(19) United States
(12) Patent Application Publication
(10) Pub. No.: US 2016/0126575 A1
(43) Pub. Date: May 5, 2016

(54) ELECTROCHEMICAL CELL

(71) Applicant: ARBL CO., LTD., Taichung (TW)

(72) Inventors: TZU-CHIEH CHAO, Taichung (TW); LI-SHEN YE, Taichung (TW)

(21) Appl. No.: 14/932,027

(22) Filed: Nov. 4, 2015

(30) Foreign Application Priority Data
Nov. 5, 2014 (TW) 103138348

(51) Int. Cl. H01M 8/06; H01M 12/06

(52) U.S. Cl. CPC H01M 8/0618; H01M 12/06; H01M 2300/0082; H01M 2008/1095

(57) ABSTRACT

The present invention discloses an electrochemical cell, comprising a negative electrode, a positive electrode, an absorption layer, and an electrolyte. The absorption layer is positioned between the negative electrode and the positive electrode and releases hydrogen ions by means of having metal ions be redox absorbed to active C—H bonds of the absorption layer. The electrolyte is positioned between the negative electrode and the positive electrode.

### CROSS-REFERENCE TO RELATED APPLICATION

This application claims the benefit of priority to Taiwan patent application Ser. No. 103138348, filed Nov. 5, 2014, which is also incorporated herein by reference.

### BACKGROUND OF THE INVENTION

1. Field of the Invention

The present invention is generally related to an electrochemical cell, and more particularly to a fuel cell.

2. Description of the Prior Art

A metal-air fuel cell using a metal fuel instead of hydrogen is a newly focused concept of fuel cells and possibly becomes a new generation of green energy. The metal-air fuel cell possesses many merits. For example, a continuous electric power generating device, being nontoxic and pollution-free and having a stable discharge voltage, high specific energy, low internal resistance, long storage life time, low cost, and low technical requirement, high specific power, can be formed by a fuel cell where metal such as zinc, aluminum instead of hydrogen is supplied to a reaction site of the cell. Thus, there are low cost resources and they are also recyclable. Furthermore, compared to a hydrogen fuel cell, the structure of a metal-air fuel cell is simple to be potentially becoming a new energy source for various applications.

A seawater cell designed and developed by Bell Laboratories and General Electric, USA, during the Second World War is one of the other new concepts of fuel cells. The seawater cell has the negative metal electrode providing the current of the negative electrode (electron flow) by eroding and dissolving the metal electrode to seawater. The positive electrode provides the current of the positive electrode by using oxygen in air or dissolved oxygen in seawater to undergo a reduction reaction on the inactive gas electrode. The extraordinary characteristic of the seawater cell is that carrying electrolyte is not necessary because natural seawater is used. In order to fulfill various different purposes, there are various types of seawater cells, such as power battery having large power to load underwater weapons, battery having small output power and long life time for underwater probing equipment and power battery for submarines.

The early developed seawater cell is a Mg/AgCl cell and its application is limited because of using high cost AgCl and high production cost. The use of magnesium (Mg) can provide a high voltage and large working current and especially its low cost magnesium makes it a good candidate as a negative electrode material for a seawater cell. Magnesium together with other metal elements can be made into magnesium alloy to further improve discharge characteristic. According to various positive electrode materials, there are various types of Mg-series seawater cells, such as Mg/AgCl, Mg/CuCl, Mg/CuSO₄, Mg/PbO₂, Mg/PbCl₂, and Mg/NiOOH.

However, the above fuel cells all have the problem of generating solid precipitates on the surface of the negative electrode due to the reaction on the negative electrode or generating a large amount of hydrogen gas, a phenomenon called “passivation of the electrode”. The precipitates or the hydrogen on the surface of the negative electrode prevent continuation of metal erosion of the negative electrode and thus result in delay and failure of the electrode reaction which of course make it unable to provide good cell performance and go for profitable mass production. Therefore, a new technique to provide reliable fuel cells with low production cost and low operational cost is urgently needed.

### SUMMARY OF THE INVENTION

In light of the above market demands, the present invention provides the following embodiments of various electrochemical cells.

In certain embodiments, the present invention provides an electrochemical cell, comprising a negative electrode, a positive electrode, an absorption layer, and an electrolyte. The absorption layer is positioned between the negative electrode and the positive electrode and releases hydrogen ions by means of having metal ions be redox absorbed (via redox substitutional reactions) to active C—H bonds of the absorption layer. The electrolyte is also positioned between the negative electrode and the positive electrode.

In certain embodiments, the negative electrode is made of metal and the absorption layer releases hydrogen ions after the metal ions derived from oxidation of the metal of the negative electrode are redox absorbed. The negative electrode is made of at least one metal selected from the group consisting of the following: aluminum, iron, magnesium, lithium, zinc, calcium and alloy of any of the above metals.

In certain embodiments, the negative electrode is made of inactive material and the metal ions are added as a form of ions or ionic compounds to the electrochemical cell. The metal ions are added as a form of ions or ionic compounds in seawater to the electrochemical cell. Preferably, the metal ions are added as a form of ions or ionic compounds in concentrated seawater to the electrochemical cell and the concentrated seawater is from a reverse osmosis seawater treatment plant.

The absorption layer reduces the metal ions to a lower oxidation state or a zero-oxidation state of the metal which is absorbed thereon. The mechanism of redox absorption includes one mechanism selected from the group consisting of the following:

˜C—H+M^{ion}+H₂O→˜C—OH+M^{red}+H⁺ and

˜C—H+M^{ion}+H₂O→˜C═O+M^{red}+H⁺.

In certain embodiments, the absorption layer reduces the metal ions to a lower oxidation state or a zero-oxidation state of the metal to have the metal be absorbed thereon so as to drastically reduce metal precipitates precipitating on the surface of the negative electrode. Further, thus generated H⁺ ions drift towards the positive electrode side and enhance the oxygen reduction reaction to boost up the whole battery action, with themselves converted to water there.

### BRIEF DESCRIPTION OF THE DRAWINGS

FIG. 1 shows a structural schematic diagram of an electrochemical cell according to one embodiment of the present invention; and

FIG. 2 shows a structural schematic diagram of an electrochemical cell according to another embodiment of the present invention.

### DESCRIPTION OF THE PREFERRED EMBODIMENTS

An electrochemical reaction is a chemical reaction on an electrode plate in which current flows through. A basic structure of an electrochemical reaction vessel includes a positive electrode, a negative electrode and an electrolyte. A device containing only one reaction vessel is called “cell” and a device containing at least two cells connected in series or parallel is called “battery”. A large battery power source, such as power source of an electric car and a backup power source, is formed by many cells connected in series and parallel.

When a cell discharges, the positive electrode undergoes a reduction process to absorb electrons to have a cathode reaction and the negative electrode undergoes an oxidation process to release electrons to have an anode reaction.

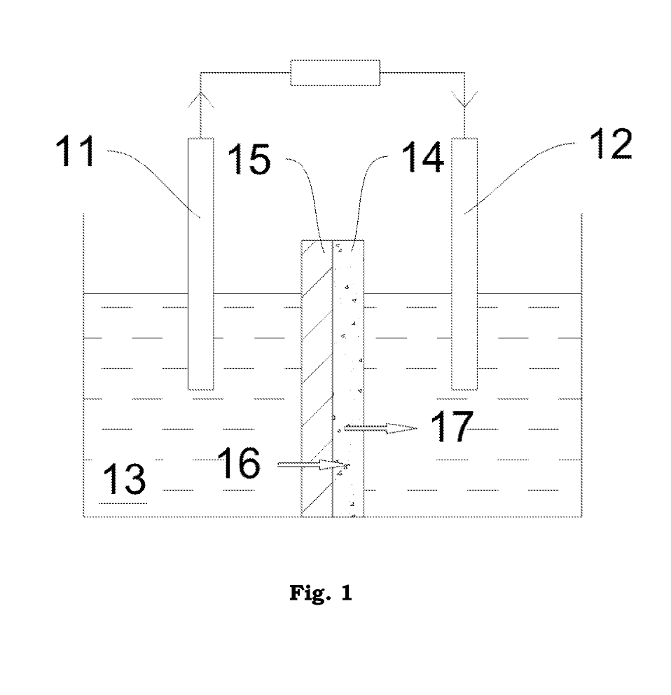

Please refer to FIG. 1. One embodiment of the present invention discloses an electrochemical cell, comprising a negative electrode 11, a positive electrode 12, an absorption layer 14 and an electrolyte 13. The absorption layer 14 is positioned between the negative electrode 11 and the positive electrode 12. The absorption layer 14 releases hydrogen ions 17 by means of having metal ions 16 be redox absorbed to active C—H bonds of the absorption layer 14. The electrolyte 13 is positioned between the negative electrode and the positive electrode. The electrolyte 13 plays a role as a state of ions to provide a current pathway in the cell and thus has to have good ionic conductivity in order to prevent generating a large internal resistance. In order to save space, the positive and the negative electrodes need to be packed closely and an isolation layer between the two electrodes is required to prevent short-circuited to cause self-discharge. In a preferred embodiment, the electrochemical cell further comprises an isolation layer 15 positioned between the negative electrode 11 and the absorption layer 14.

In one embodiment, the negative electrode 11 is metal and the absorption layer 14 releases the hydrogen ions 17 by redox absorption of the metal ions 16 derived from oxidation of the metal of the negative electrode 11. The electrochemical cell of this embodiment can be a metal-air cell.

The operating principle of a metal-air cell is to use active solid metal (aluminum, iron, magnesium, lithium, zinc, calcium and alloy of any of the above metals) as a fuel source and an alkaline or neutral water-soluble salt as an electrolyte. The negative electrode in the cell is a consumable active metal electrode and the positive electrode is an inactive electrode for reduction of oxygen. The positive electrode can be a carbon rod, nickel mesh, or air diffusion electrode. The reaction of the positive electrode is reduction of oxygen, shown as follows:

O₂+2H₂O+4e⁻=4OH⁻ (Eₒ=+0.401V)

The theoretical energy density of a metal-air cell depends on the negative electrode, that is, fuel electrode which is the only active substance transferred in the cell and oxygen is led from air during the discharge process. The discharge reaction on the metal electrode depends on the metal and electrolyte used during discharge or other factors. The discharge reaction has the following general equation:

M=Mⁿ⁺+ne⁻

The total discharge reaction of the cell is:

4M+nO₂+2nH₂O=4M(OH)ₙ

where M represents a metal, n represents a value changes in the valance state during oxidation of metal and Mⁿ⁺ represents the metal ion. Most of metals are not stable in the electrolyte and undergo erosion or oxidation to produce hydrogen gas, shown as follows.

$$M + {nH}_{2} O = {M ( OH )}_{n} + \frac{n}{2} {H}_{2}$$

Taking an Mg/Air cell as an example, the positive electrode of a general Mg/Air cell is a carbon rod but not air diffusion electrode and the electrolyte is a positive electrode electrolyte and the Mg/Air cell is also called “semi-fuel cell”. Magnesium and aluminum both have high Faraday efficiency, a low density, and high standard potential. In addition, a cell using magnesium as the positive electrode can use a neutral electrolyte to have broad applications in underwater power sources so as to draw great attention.

The theoretical electro-motive force of the discharge reaction of the Mg/Air cell is 3.1V. The actual open-circuited voltage is about 1.6V. The magnesium electrode can easily directly react with the electrolyte to form Mg(OH)₂ and generate hydrogen gas. The formed Mg(OH)₂ and hydrogen gas cover the surface of the electrode to form a blockage layer so that the erosion reaction is greatly slowed down. At the time, the film of Mg(OH)₂ covering on the magnesium electrode causes serious delay and failure of the electrode reaction. Because the “deactivated” magnesium electrode cannot provide good cell performance, the Mg/Air cell has not yet been commercialized.

In one embodiment of the present invention, the absorption layer 14 is used to have the metal ions 16 undergo redox absorption to reduce the metal ions 16 to a lower oxidation state or a zero-oxidation state of the metal which is absorbed on the absorption layer 14. Therefore, the phenomenon of precipitating metal precipitates (for example Mg(OH)₂) on the surface of the negative electrode 11 can be significantly reduced to prevent the reaction of the negative electrode from delay or failure.

The mechanism of having the metal ions 16 undergo redox absorption by the absorption layer 14 to release hydrogen ions 17 disclosed in this embodiment includes one mechanism selected from the group consisting of the following or combination thereof:

˜C—H+M^{ion}+H₂O→˜C—OH+M^{red}+H⁺ and

˜C—H+M^{ion}+H₂O→˜C═O+M^{red}+H⁺

where the superscript “ion” represents the ionized state, the superscript “red” represents the reduced state and M^{ion} represents the metal ion 16.

On the other hand, the reduction reaction of oxygen on the positive electrode 12 is as follows:

4H⁺+O₂+4e⁻=2H₂O

Since the absorption layer 14 has the metal ions 16 undergo redox absorption to also release hydrogen ions 17, the electrochemical reaction is promoted to significantly reduce hydrogen generation nearby the negative electrode 11. In one preferred embodiment, the total quantity of hydrogen generated nearby negative electrode 11 is less than or equal to 45 ml/per gram of metal of the negative electrode.

The absorption layer 14 comprises activated carbon fibers (ACF). According to raw materials, the activated carbon fibers can be categorized into polyacrylonitrile (PAN), rayon, pitch, phenolic, cellulose, polyvinylidene chloride (Saran), etc. The activated carbon fibers are obtained from undergoing firstly a fiber-spinning process and then stabilization, carbonization and activation processes. The activation process includes physical and chemical activation. In one preferred embodiment, the absorption layer 14 is hydrophilic.

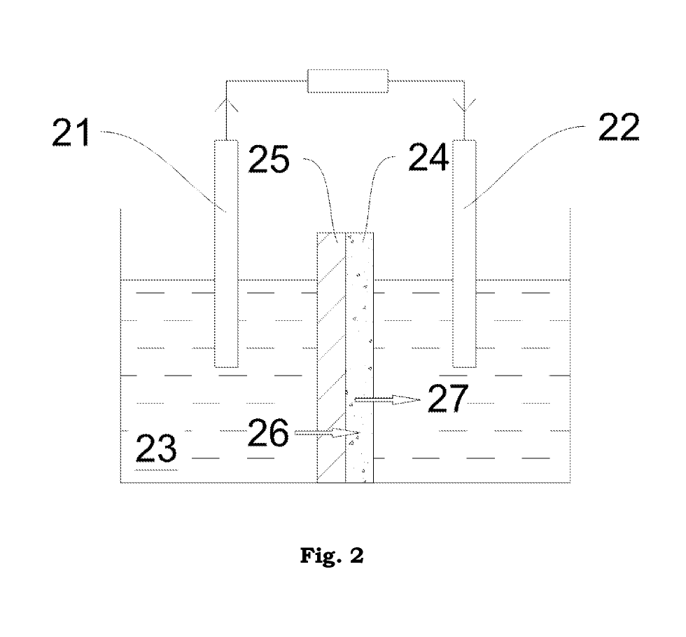

Please refer to FIG. 2. Another embodiment of the present invention discloses an electrochemical cell, comprising a negative electrode 21, a positive electrode 22, an absorption layer 24 and an electrolyte 23. The absorption layer 24 is positioned between the negative electrode 21 and the positive electrode 22 and the absorption layer 24 releases hydrogen ions 27 by means of having metal ions 26 undergo redox absorption to active C—H bonds of the absorption layer 24. The electrolyte 23 is positioned between the negative electrode 21 and the positive electrode 22 and physically can be a dry one in form, called “polymer electrolyte membrane” (PEM), which lets through proton flow but not the electron flow. The PEM may be perfluorocarbon polymer of a sulfonic acid type, perfluorocarbon polymer having a phosphonic acid group or carboxylic acid function. More specifically, the PEM may be perfluoroacid polymers including Nafion™ from DuPont, Flemion™ from Asahi Glass Company and Aciplex™ from Asahi Kasei Corporation. In a preferred embodiment, the electrochemical cell further comprises an isolation layer 25 positioned between the negative electrode 21 and the absorption layer 24.

In one embodiment, the negative electrode 21 is made of inactive material and the metal ions 26 are added as a form of ions or ionic compounds to the electrochemical cell. In this embodiment, the electrochemical cell is a seawater cell. In a preferred embodiment, the metal ions 26 are added as a form of ions or ionic compounds in seawater to the electrochemical cell. The commonly seen metal ions in seawater include sodium ion, magnesium ion, calcium ion and potassium ion. Preferably, the metal ions 26 are added as a form of ions or ionic compounds in concentrated seawater to the electrochemical cell and the concentrated seawater can be from a reverse osmosis seawater treatment plant. Since the concentration of metal ions in concentrated seawater is higher, the efficiency of the cell reaction can be further promoted.

As described in the above, the positive electrode 22 of the seawater cell uses oxygen in air or dissolved oxygen in seawater to undergo the reduction reaction on the inactive gas electrode to provide the positive electrode current. Besides, natural seawater can be used as the electrolyte 23.

Since the content of dissolved oxygen is low and the reduction potential of oxygen is high, the cathode material for promoting the reduction reaction of oxygen is needed. The equilibrium potential of the reduction reaction of oxygen at the pH value of seawater and the concentration of dissolved oxygen of seawater is 0.45V. In order to obtain the higher working potential, a catalyst is used to reduce the overpotential of the reduction reaction of oxygen. For example, the technique of catalyzing the positive electrode of the fuel cell can be used to reduce the overpotential of the reduction reaction of oxygen to a minimum. If the positive electrode 22 of the seawater cell uses oxygen in air, the positive electrode material is relatively simple and can be for example a material for a general inactive electrode like carbon rod, nickel mesh, air diffusion electrode.

The mechanism of having the metal ions 26 undergo redox absorption by the absorption layer 24 to release hydrogen ions 27 disclosed in this embodiment includes one mechanism selected from the group consisting of the following or combination thereof:

˜C—H+M^{ion}+H₂O→˜C—OH+M^{red}+H⁺ and

˜C—H+M^{ion}+H₂O→˜C═O+M^{red}+H⁺

where the superscript “ion” represents the ionized state, the superscript “red” represents the reduced state and M^{ion} represents the metal ion 26.

On the other hand, the reduction reaction of oxygen on the positive electrode 22 is as follows:

4H⁺+O₂+4e⁻=2H₂O

Since the absorption layer 24 has the metal ions 26 undergo redox absorption to also release hydrogen ions 27, the electrochemical reaction is promoted to significantly reduce hydrogen generation nearby the negative electrode 21.

Moreover, a large amount of the microparticles, Mg(OH)₂ ionic compounds, exist in seawater. Because they are slightly dissolved in water, they can provide a negative electrode half reaction when used in the cell:

Mg(OH)₂→Mg²⁺+2OH⁻

where the magnesium ion reacts with the active C—H bonds of the absorption layer 24 to generate the hydrogen ion (moving to the positive electrode 22) and OH⁻ reacts with Mg atom derived from the redox reaction of the C—H bonds (or externally added Mg atom). The electrons generated nearby the negative electrode 21 and finally flowing through the external circuit are:

Mg+2OH⁻→Mg(OH)₂+2e⁻

where Mg(OH)₂ microparticles precipitate on the location of the active C—H bonds of the absorption layer 24 but not form a film on the traditional magnesium electrode. Mg(OH)₂ microparticles undergo hydrolysis any time.

The operation of a conventional seawater cell has low reaction efficiency because of deactivation of the electrode. Thus, it needs consume a large amount of metal material of the negative electrode. In this embodiment, the metal ionic compounds in seawater or concentrated seawater are used as the consumable negative electrode reactive materials. When the metal ionic compounds are completely consumed or the water completely evaporates, new seawater can be added. Not only is the diffusion of hydrogen to the positive electrode increased to promote the reaction efficiency, but also the additional external electron flows are provided to reduce the actual consumption of the negative electrode reactive materials. The concept of environmental protection is fulfilled and also the operating cost is reduced.

In this embodiment, the electron flows needed by the seawater cell can be partially provided from an external device. For example, a solar energy plate or a device of converting mechanical energy to electric energy can be implemented.

Obviously many modifications and variations are possible in light of the above teachings. For example, the whole invented cell can be non-aqueous, with the electrolyte being a dry Nafion film, as in most existing fuel cells. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. An electrochemical cell, comprising:
a negative electrode;
a positive electrode;
an absorption layer, being positioned between the negative electrode and the positive electrode and releasing hydrogen ions by means of having metal ions be redox absorbed to active C—H bonds of the absorption layer; and
an electrolyte, being positioned between the negative electrode and the positive electrode.

2. The electrochemical cell according to claim 1, wherein the negative electrode is made of metal, and the absorption layer releases hydrogen ions after the metal ions derived from oxidation of the metal of the negative electrode are redox absorbed.

3. The electrochemical cell according to claim 2, wherein the negative electrode is made of at least one metal selected from the group consisting of the following: aluminum, iron, magnesium, lithium, zinc, calcium and alloy of any of the above metals.

4. The electrochemical cell according to claim 1, wherein the negative electrode is made of inactive material, and the metal ions are added as a form of ions or ionic compounds to the electrochemical cell.

5. The electrochemical cell according to claim 4, wherein the metal ions are added as a form of ions or ionic compounds in seawater to the electrochemical cell.

6. The electrochemical cell according to claim 4, wherein the metal ions are added as a form of ions or ionic compounds in concentrated seawater to the electrochemical cell, and the concentrated seawater is from a reverse osmosis seawater treatment plant.

7. The electrochemical cell according to claim 4, wherein the ionic compound added is Mg(OH)₂ which sufficiently dissolves in water.

8. The electrochemical cell according to claim 4, wherein the absorption layer reduces the metal ions to a lower oxidation state or a zero-oxidation state of the metal to have the metal be absorbed thereon.

9. The electrochemical cell according to claim 1, wherein the absorption layer comprises activated carbon fibers (ACF).

10. The electrochemical cell according to claim 1, wherein the absorption layer is hydrophilic.

11. The electrochemical cell according to claim 1, wherein the mechanism of metal ions be redox absorbed includes one mechanism selected from the group consisting of the following or combination thereof:
˜C—H+M^{ion}+H₂O→˜C—OH+M^{red}+H⁺ and
˜C—H+M^{ion}+H₂O→˜C═O+M^{red}+H⁺.

12. The electrochemical cell according to claim 1, wherein the electrolyte includes a water-soluble salt.

13. The electrochemical cell according to claim 2, wherein hydrogen released nearby the negative electrode is less than or equal to 45 ml/per gram of metal of the negative electrode.

14. The electrochemical cell according to claim 1, further comprising an isolation layer positioned between the negative electrode and the absorption layer.

15. The electrochemical cell according to claim 1, wherein the positive electrode is an inactive electrode for oxygen to undergo a reduction reaction.

16. The electrochemical cell according to claim 1, wherein the positive electrode is selected from the group consisting of the following: carbon rod, nickel mesh, and air diffusion electrode.

17. The electrochemical cell according to claim 1, wherein the electrolyte includes polymer electrolyte membrane (PEM).
